(19) United States
(12) Patent Application Publication
(10) Pub. No.: US 2004/0111528 A1
(43) Pub. Date: Jun. 10, 2004

(54) Method and apparatus for reducing the bandwidth of a wireless network

(75) Inventor: Wassim Haddad, Verdun Municipality (CA)

Correspondence Address: HEWLETT-PACKARD COMPANY, Intellectual Property Administration, P.O. Box 272400, Fort Collins, CO, 80527-2400, US

(73) Assignee: HEWLETT-PACKARD DEVELOPMENT COMPANY, L.P.

(21) Appl. No.: 10/697,043

(22) Filed: Oct. 31, 2003

(30) Foreign Application Priority Data
Nov. 16, 2002 (GB) 0226836.5

(51) Int. Cl. G06F 15/16

(52) U.S. Cl. 709/236

(57) ABSTRACT

A method of reducing the bandwidth required to operate a wireless network comprising transmitting at least a first and a second advertisement according to different network protocols in the same, or substantially the same, frequency channel. Such an arrangement may be suitable for areas which are covered by two or more network protocols.

### FIELD OF THE INVENTION

This invention relates to a method and associated system for reducing the bandwidth required for a wireless network and associated apparatus.

### BACKGROUND OF THE INVENTION

Session Initiation Protocol (SIP) is a known network protocol for Internet conferencing, telephony, events notification and instant messaging that facilitates call setup, routing, authentication. Servers are known that can provide the functionality provided by SIP, and this requires that a periodic advertisement signal be transmitted by that server and may be thought of as announcing that server's presence.

Cellular networks are known in which mobile telephones, and other devices, can operate and examples of such networks are the GSM (Global System for Mobile communication), GPRS (General Packet Radio Service) and Universal Mobile Telecommunications System (UMTS) networks. These networks, like servers running SIP, provide an advertisement that provides information to the telephone, or the like, about that cell. This periodic advertisement is provided over a BCCH (Broadcast Control CHannel). The advertisement comprises an identifiable bit stream provided on within one of the frequency channels on which the cell in which the telephone is situated is capable of communicating. That particular frequency channel is the BCCH for that cell. The telephone can detect the bit stream and scans the channels of the cell until the BCCH is located. The periodic advertisement provides a mechanism for telephones or other communication devices within the network to communicate with a server of the network so that conversations or other data transmission can be transmitted at the correct frequency.

### SUMMARY OF THE INVENTION

According to one aspect of the invention there is provided a method of reducing the bandwidth required to operate a wireless network comprising transmitting at least a first and a second advertisement according to different network protocols in the same, or substantially the same, frequency channel.

### BRIEF DESCRIPTION OF THE DRAWINGS

Embodiments of the present invention is now described by way of example only and with reference to the following drawings of which:

FIG. 1 shows an example of a wireless network;

FIG. 2 schematically shows a server for use in with present invention;

FIG. 3 schematically shows a mobile communication device for use with the present invention;

FIG. 4 shows a prior art arrangement of cells within a network;

FIG. 5 shows an arrangement of cells within a network;

FIG. 6 shows a flowchart outlining the process of the present invention; and

FIG. 7 shows the seven layer OSI model.

### DETAILED DESCRIPTION OF SPECIFIC EMBODIMENTS OF THE INVENTION

One aspect of the invention is directed to provision of a method of reducing the bandwidth required to operate a wireless network comprising transmitting at least a first and a second advertisement according to different network protocols in the same, or substantially the same, frequency channel—features of embodiments according to this aspect will now be generally described.

Such an arrangement is advantageous because it reduces the amount of the available frequency spectrum that is taken up by transmission of advertisements, thus making available more of the spectrum for communications and other information.

The advertisements are for different network protocols and for example, the first advertisement may comprise a first network protocol and the second advertisement may comprise a second network protocol. In particular the first advertisement may be transmitted according to the SIP protocol and the second advertisement may be transmitted according to a cellular telephone network protocol (for example GMS, GPRS, UMTS, or any other such network). Indeed, the method may be applicable to other network protocols such as IEEE 802.11 (often referred to as WIFI), or any other network protocol that relies on the transmission of advertisements.

This method is particularly applicable to network which comprises a plurality of cells; i.e. a cellular network, but may have wider applicability. It will be appreciated that cells within a cellular network may be of varying area and that the area is generally related to the potential volume of data to be transmitted on the network within that cell. Thus, in populated areas, cells tend to be of smaller area than in less populated areas.

One of the first and second advertisements may cover more than one cell of the cellular network. In an embodiment in which the first advertisement is transmitted according to SIP and the second advertisement is transmitted to a cellular telephony based network protocol then the first advertisement may extend over a plurality of cells. Such an arrangement is particularly advantageous when the area of the cell is of a smaller area, perhaps in populated areas, since the number of transmitters capable of transmitting a first and a second advertisement is reduced. Reduction of the number of transmitters may lead to reduction in the hardware costs, maintenance costs, complexity of the system and the like.

The method may be arranged such that at least one of the advertisements, conveniently an advertisement according to the SIP, contains location information. Such an arrangement is convenient because it may allow the location of a communication device operating within the wireless network to determine its position by reading the location information.

Conveniently, the location information takes the form of a SIP address.

The skilled person will appreciate that being able to determine the location of a communication device within the cellular network potentially allows a plurality of location specific services to be provided. For example, the method may allow a communication device to determine the presence of a desired service within its location. The desired service may for example include the location of a restaurant or other service providing outlet within the vicinity of the communication device; it may allow a taxi, or the like to be directed to the location of the communication device; it may allow emergency services to be directed to the location of the communication device; and many other services. The services listed are by way of example only and are not intended to provide an exhaustive list.

Conveniently, the first and second advertisement are transmitted periodically, and may be one after the other. However, other arrangements may be possible. For example, it may be possible to encapsulate one of the advertisements within the other.

Both the first and the second advertisements may be sent using the same transport protocol. For example, the first and second advertisement may both be sent according to IP. The skilled person will appreciate that other transport protocols are also possible.

In a further aspect, there is provided a processing unit comprising a transmitter arranged to transmit data in at least one frequency channel wherein said transmitter is arranged to transmit a first advertisement according to a first network protocol in said frequency channel and a second advertisement according to a second network protocol in said frequency channel, or substantially said frequency channel. Features of embodiments according to this aspect will now be generally described.

Said processing unit may comprise a server provided within a cellular network, or may comprise a processing unit within said cellular network in communication with one or more servers thereof. The processing unit may for instance comprise a base station of a network.

According to a further aspect of the invention there is provided a communication device comprising a receiver arranged to receive signals in at least one frequency channel, said receiver further being arranged to receive a first advertisement transmitted according to a first network protocol in said frequency channel and to receive a second advertisement transmitted in the same, or substantially the same, frequency channel. Features of embodiments according to this aspect will now be generally described.

Such a communication device is advantageous because it may reduce the complexity of the receiver within the communication device. Prior art communication devices have required receivers for each of the networks to which they can connect making them more complex than may be desired. For example, if a communication device were capable of connecting to a WIFI network and a cellular network, it would require a receiver capable of receiving an advertisement from both these networks.

According to a further aspect of the invention there is provided a wireless network comprising at least one transmitter arranged to transmit data in at least one frequency channel, said transmitter being arranged to transmit a first advertisement according to a first network protocol in said frequency channel and a second advertisement according to a second network protocol in said frequency channel, or substantially said frequency channel. Features of embodiments according to this aspect will now be generally described.

Generally, said network will comprise a network comprising a plurality of cells; that is a cellular network.

In a further aspect of the invention there is provided a method of locating a communication device within a cellular network comprising transmitting an advertisement that contains location information—features of embodiments according to this aspect will now be generally described.

Such a method is convenient because it may allow services to be provided according to the location of the device as described above.

The advertisement may comprise an advertisement according to the SIP. Conveniently, in some locations the location information provided by the advertisement may extend over more than one cell of the cellular network. Such a method may be particularly convenient for cells that are in densely populated areas which tend to be of a smaller area than those in less populated areas.

Machine readable media may be provided to allow implementation of methods described both above and below. These may be any one or more of the following, or indeed any suitable machine readable medium: a floppy disk; a CDROM, a DVD ROM/RAM (including +RW/−RW); any form of magneto optical disk; a hard drive; a memory device; a transmitted signal (including an internet download; ftp transfer; any other file transfer, or the like); a wire.

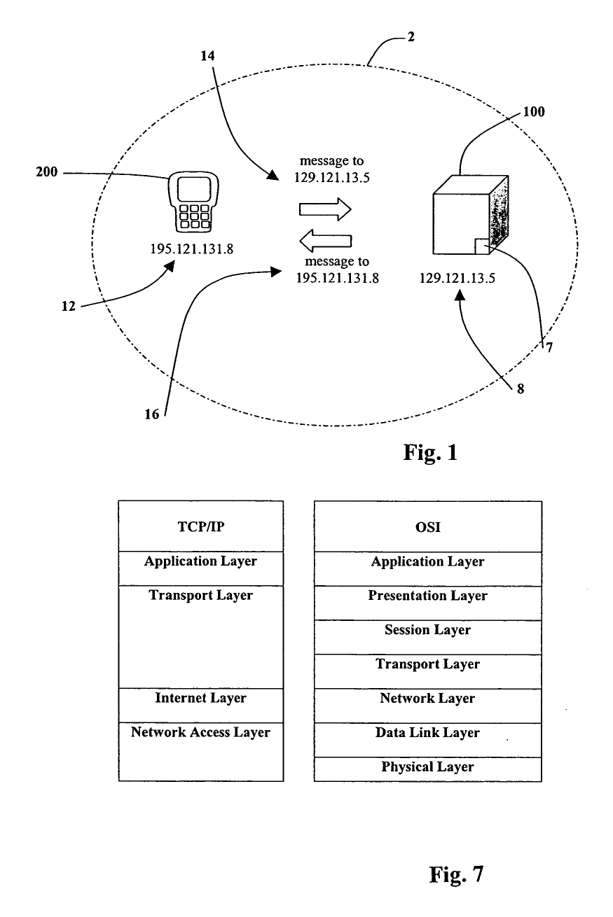

An example of a wireless network 2 is shown in FIG. 1 and comprises a server 100 which has a network address 8 and comprises a UMTS hub 7 to generate the network 2. In this example the network generated by the server 100 is a UMTS (sometimes referred to as 3G) network and may provide a cell operating on an available UMTS channel, but of course any other available wireless network protocol may be suitable (for example WIFI). The server 100 has a network address 8, which in this example is 129.121.13.5 which follows the well known TCP/IP protocol as will be well understood by the skilled person. In communication with the server 100, via the wireless network 2, is a mobile communication device 200, which in this case is a laptop PC. The computing device also has a network address 12, again following the well known TCP/IP format. Again, it will be appreciated by the skilled person that other network addresses formats may be possible and that the TCP/IP format is provided merely be way of example. Data packets 14 sent from the computing device to the server 100 contain the network address 8 of the server, and likewise data packets 16 for the communication device 200 contain the network address 12 of the communication device 200.

FIG. 2 schematically shows the architecture of a server 100 as shown in FIG. 1. A processing means 101 (in this case the processing means comprises 2 or 4 processors generally an Intel Pentium 4 or the like running at or above 2 GHz), is connected, via a bus 102, to a memory 104, and a hard drive array 106. The bus 102 also connects the processor to a display driver 108, which can drive a monitor connected to an output interface 110. An input/output controller 112 also connects to the bus 102 and allows a keyboard, mouse, etc. to be connected the processor 101 via ports 114 (which in this embodiment comprise Universal Serial Bus (USB) ports). A network controller 116 connects the processing means 101 to a network via an output port 118. The processing means 101 is further connected to an IP port 120, which provides access to the Internet. The server 100, together with network adapters, provides the necessary processing circuitry to operate a network which may be similar to that shown in FIG. 1.

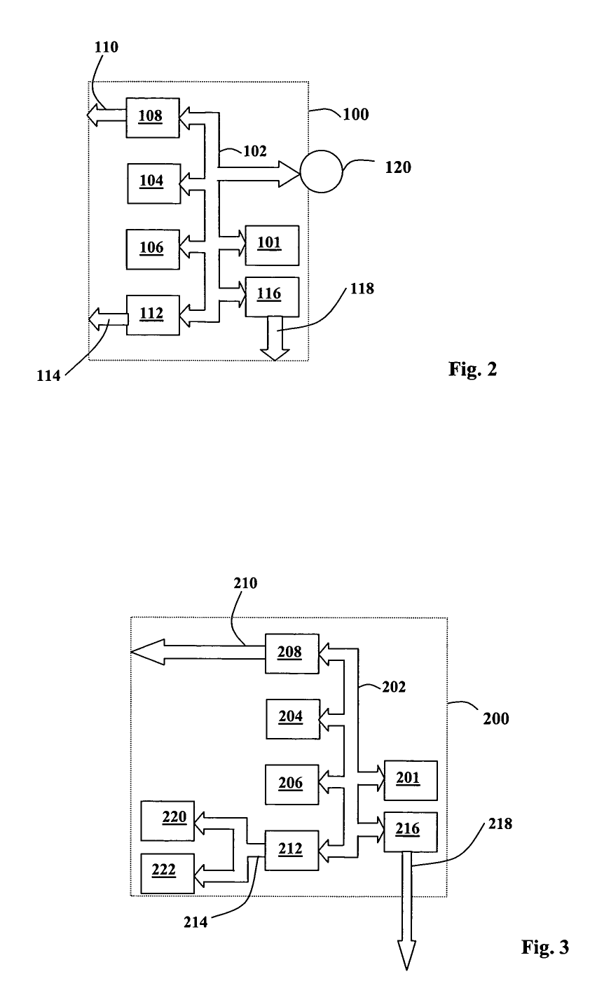

FIG. 3 shows an example of a mobile communication device that could be connected to the network. In the example shown, the communication device 200 is a mobile telephone running WAP (Wireless Application Protocol) to enable it to connect to a UMTS (Universal Mobile Terrestrial System) cellular network. However, in other embodiments the communication device may be designed to connect to a different network for example a GPRS (General Packet Radio Service), a GSM (Global System for Mobile communication) cellular network, any may be another form of communication device. The communication device may, for example, be a portable PC running the LINUX operating system, Microsoft™ Windows™ 2000, XP™, or the like, Apple™ iBooks™, a PDA, or any other form of communication device.

The structure of the mobile communication device 200 of this example is as follows. A processing means 201 (in this case a processing means comprising an ARM™ core) is connected, via a bus 202, to a memory 204. The bus 202 also connects the processing means 201 to a display driver 208, which can drive an LCD display connected to an output interface 210. An input/output controller 212, is also connected to the bus 202 and drives a keyboard 220 and a microphone and speaker 222 via a connection 214 and allow a user to make inputs thereto. A network access means, in this case allowing access to a UMTS network 216, connects the processing means 201 to a network via an aerial 218 which in this case is external to the communication device 200.

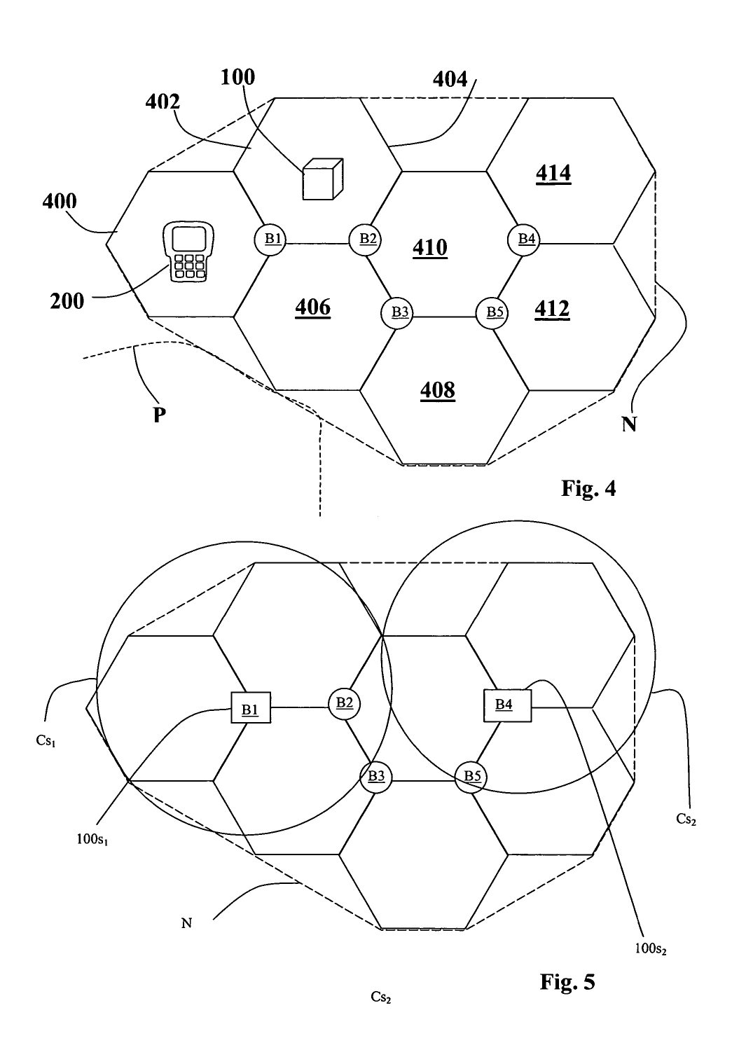

FIG. 4 shows a cellular network N provided by a plurality of base stations B1, B2, B3, B4, B5, which each periodically transmit an advertisement within a frequency channel, referred to as a Broadcast Control Channel (BCCH). The data contained in this advertisement is locally unique to the base station B1, B2, B3, B4, B5 from which it originates. Each base station may be thought of as a processing unit having a transmitter associated therewith.

The available frequencies for a given network are divided into a plurality of frequency channels with each channel capable of supporting a communication. For example, in one implementation of a GSM network the available frequencies are 890-915 MHz for the uplink (communication device 200 to base station B1-B5) and 935-960 MHz for the downlink (base station B1-B5 to communication device 200). Therefore, a total of 25 MHz is available for both the down and up links. This available bandwidth is divided into 124 200 kHz frequency channels, and a 100 kHz guard band is provided at either end. When a communication device 200 connects to a base station B1-B5 it is allocated one of the downlink frequency channels and one of the uplink frequency channels. One of the downlink frequency channels is allocated as the BCCH for that cell.

The advertisement comprises an identifiable bit stream provided within one of the frequency channels on which the cell in which the telephone is situated is capable of communicating. That particular frequency channel is the BCCH for that cell. The communication device 200 can detect the bit stream and scans the channels of the cell until the BCCH is located. The periodic advertisement provides a mechanism for communication device 200 within the network to communicate with a server of the network so that conversations or other data transmission can be transmitted at the correct frequency.

Looking at FIG. 4 it can be seen that a base station B1-B5 is provided at the junction of plurality of cells. For example, the base station B1 is provided at the junction of cells 400, 402, 406. It would of course be possible to provide the base station within a cell, or in any other arrangement.

The advertisement has the function of informing the communication device 200 of the presence of the network N to which a connection can be made. In this embodiment, the network N is controlled by the server 100 provided on the cellular data network. Each of the base stations B1-B5 is connected to the server 100, although these connections are not shown for the sake of clarity. It will be appreciated that in fact it is likely that the network comprises a plurality of servers, each of which communicates in order to provide the network.

The communication device 200 is connected to a UMTS cellular network via a wireless connection. The network connection is provided between the communication device 200 and one of the plurality of base stations B1, B2, B3, B4, B5 of the network N by means of a bi directional link established using the aerial 218. Generally, the communication device will be connected to the base station B1-B5 from which the signal received is strongest, which is usually that which is closest geographically. However, this need not be the case. For example if the closest base station does not have the bandwidth to connect the communication device 200 it may be connected to a more remote base station B1-B5.

Each base station B1, B2, B3, B4, B5 has many bi-directional channel pairs; with each pair comprising a voice connection and a signalling connection. The voice connection is used to transmit voice messages and the signalling connection is used to transmit the data required to interact with applications running on the server 100 (for example access registration/authentication or system resources access, data transfer, etc.).

It will be appreciated that it can be convenient to be able to detect the whereabouts of a mobile communications device 200. Consider the following examples. The user of the communications device 200 may be in an area with which they are not familiar, and may wish to know of any local Italian restaurants. Alternatively, the user may require a taxi—if the dispatcher of the taxi can ascertain where the user of the communication device 200 is, he/she can instruct the closest available taxi to them, even if the user is unsure of his/her own location. In another example, the user of the communication device may have called for the emergency services and may be unable to give their location.

Session Initiation Protocol (SIP) is a known network protocol for Internet conferencing, telephony, events notification and instant messaging and facilitates call setup, routing, authentication. Servers are known that can provide the functionality provided by SIP, and this requires that a periodic signal be transmitted by that server announcing the server's presence. This periodic signal may also be thought of as an advertisement and allows communication devices on the network to connect to the server, which may be referred to as a SIP server.

As shown in FIG. 5 a second network is overlaid on the network N described above. This second network provides a plurality of servers (in this case a first server 100S₁ and a second server 100S₂) capable of producing a signal, or an advertisement, identifying the server from which it originates. The first server 100S₁ has been implemented on the base station B1 and the second server 100S₂ has been implemented on the base station B2.

Each device connecting to the SIP server 100S₁, 100S₂ is given an address, often referred to as a SIP address, which changes according to the SIP server to which the communication device is connected. For example assuming that the communication device is given the unique identity device1 its address when connected to the first SIP server may be device1@100S₁.HP. When the same communication device connects to the second server it address may become device1@100S₂.HP. Thus, in the present arrangement the latter portion of the SIP address gives an idea of the location of the communication device (since it details the sever to which the device is connected). Generally prior art devices have used GPS (Global Positioning System) to provide location information.

In the network shown in FIG. 5 the advertisement from the SIP server 100S₁, 100S₂ and the advertisement from a base stations B1-B5 are both transmitted in a single frequency channel. Allotting only one frequency channel in place of two reduces the signal load on the network, and, as both advertisements are only emitted periodically, the present system proposes that the SIP servers 100S₁, 100S₂ and the base stations B1-B5 to emit their advertisements at different times to avoid interference and the advertisements are transmitted one after the other.

Implementing the server on the base station allows advertisements for both SIP and UMTS to be generated without collision thereof. It would of course be possible to implement the server on a computing unit other than the base station, but a mechanism to avoid collision of the advertisements may then be needed.

However, in another embodiment, the advertisement transmitted by the SIP servers 100S₁, 100S₂ are encapsulated within the frequency channel (the BCCH). Such an arrangement is convenient because it allows a single transceiver to transmit both the SIP advertisement and the BCCH advertisement.

It will be appreciated that the advertisements from the SIP servers maybe used to provide location information.

There follows a brief discussion of the technology employed in these embodiments. A person skilled in the art will familiar with the seven layer OSI (Open Systems Interconnection) model, the networking industry's standard model for network protocol architecture which is shown for convenience in FIG. 8. The OSI model describes a modular structure where by data is transformed from a user-input level (the top layer) to a stream of electronic or analogue pulses which are transmitted over the network. Under this model, a communication device 200 is given an IP address when it connects to a network to identify it to that network as a function of the network layer, one of the lower layers of the OSI model.

Communication devices 200 communicating with the network N as shown in FIG. 4 connect to a base station by liasing with that base station B1-B5 over the BCCH. The BCCH advertisement is transmitted by a particular base station in one of the frequency channels available from that base station B1-B5. The selected frequency channel becomes the BCCH for that base station B1-B5. A communication device 200 locates the BCCH by scanning the frequency channels to locate the advertisement in the BCCH which comprises an identifiable bit stream. The advertisement contains information required by the communication device 200 to transmit information across the network. Therefore, as the communication device 200 moves through the network N it remains in contact with the network by this advertisement over the BCCH. However, this advertisement gives no indication of the location of the communication device 200. Data/voice signals are generally not transmitted over the BCCH and transmitted at frequencies specified in the advertisement with the base station B1-B5 over the BCCH.

If a packet based communication link has been established between the communication device and the network (i.e. a link in which data is transmitted in packets according to a transport protocol—perhaps TCP/IP, or other similar transport protocol) a care of address may be assigned. When the communication device 200 connects to the network it is assigned an address, generally unique, or it may have its own dedicated address which is the same in whichever network to which it connects (for example an email address). As this communication device moves from one network N to a neighbouring network P then the network P may assign a care of address to that communication device 200 allowing data packets to be forwarded to the communication device 200 within the network P. As discussed previously communications are instigated using the BCCH of the network P. This care of address may be provided by mobile IP and will be well understood to the person skilled in the art, but may be thought of adding an additional header to the packets that routes the packet through the network in which the care of address applies.

As discussed above, under SIP a communication device for example a WAP mobile telephone is assigned a further address, known as a SIP address, when it connects to a SIP server. The SIP address is assigned at the application layer, the highest layer of the OSI model, and the layer with which a user of the system communicates directly. A SIP server will assign addresses according to logical addressing protocols. Part of the address will identify the SIP server 100S₁, 100S₂ that assigned it. In the prior art it is therefore possible that the communication device 200 received two advertisements in two frequency channels: one from the base stations B1-B5 and one from the severs 100S₁, 100S₂. In an embodiment of the present invention the advertisement for each of the networks is transmitted in the same frequency channel.

A representation of such a system is shown in FIG. 5. Two SIP servers 100S₁, 100S₂, are provided. These each emit a signal, each signal defining a network cell CS₁, CS₂. As shown in the Figure, the network cells CS₁, CS₂ need not cover the same physical area defined by the network cells of the underlying network, although it is possible that they may do so.

The SIP servers 100S₁, 100S₂ (and any other SIP servers on the network) are connected to one another so that information about which communication devices 200 are connected to any one server can be passed between the servers 100S₁, 100S₂.

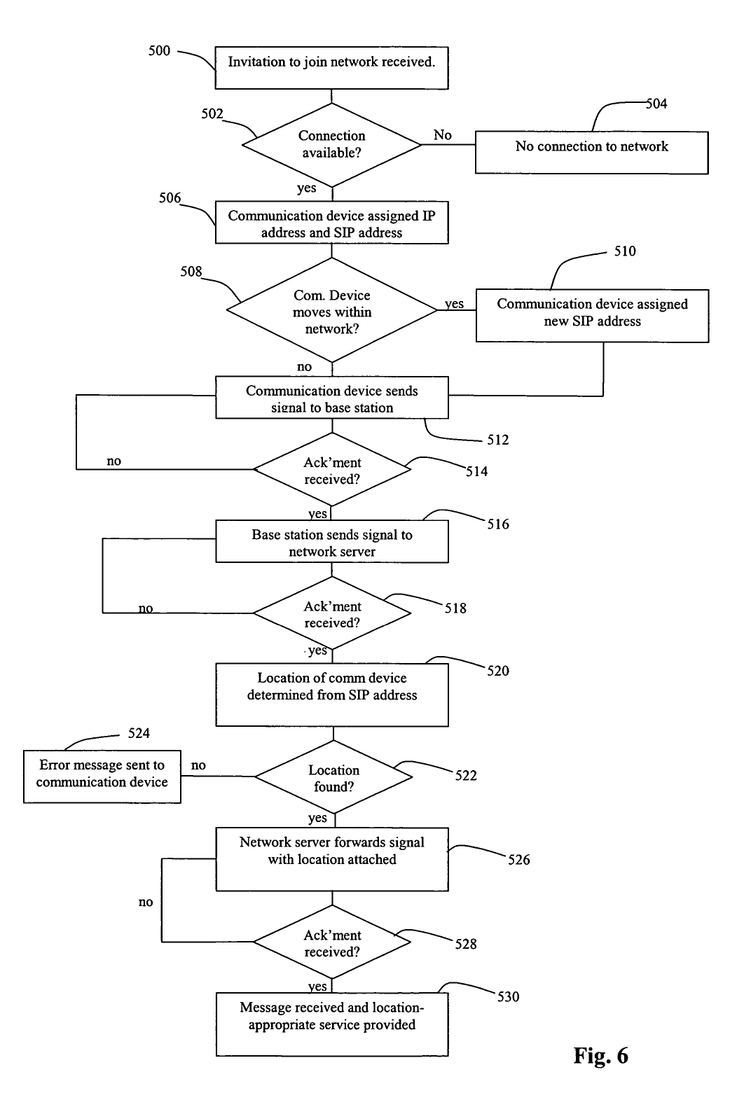

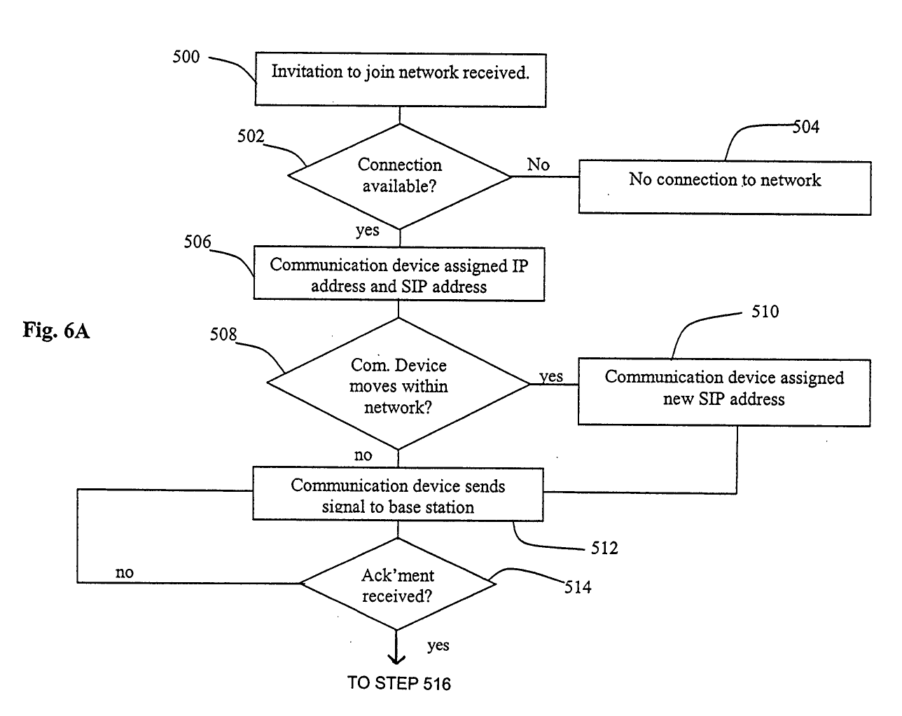

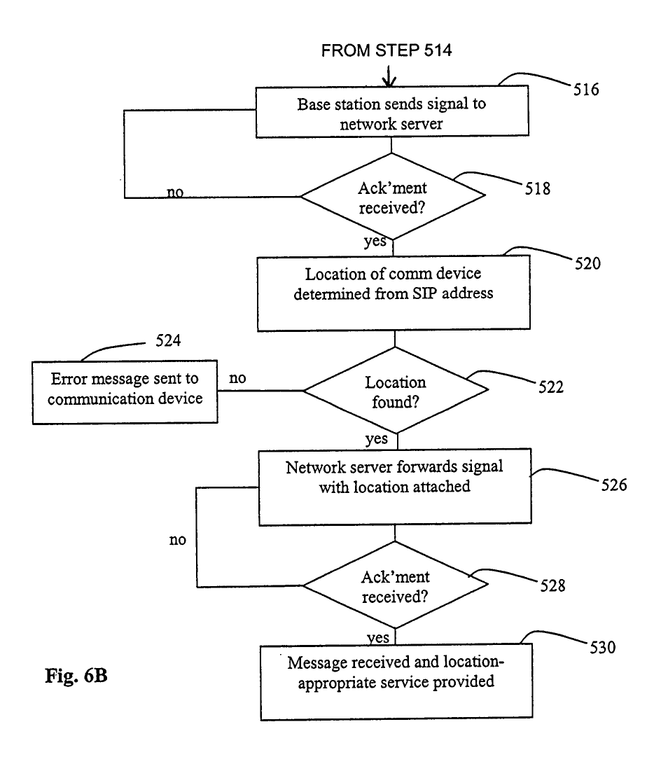

In use of the system, the communication device performs as follows and explained with reference to FIG. 6.

The user of the communication device 200 attempts to initiate a connection to a network. If a network covers the area, the aerial 218 of the communication device 200 receives a signal and the communication device 200 scans the frequency channels to locate the BCCH in that cell which contains an advertisement for the network and for the nearest SIP server, which in this example is the first SIP server 100s₁ (step 500). Applications running on the communication device 200 will initiate a “handshake” process to negotiate access to physical resources.

In brief, a physical interface module of the communication device 200 negotiates service parameters with the physical interface module of the server 100S₁, which will attempt to reserve system resources for the user by appropriate means, specific to each mobile network implementation.

If the required resources are available (for example, but not limited to, bandwidth on the wireless air interface) (step 502), the communication device 200 will be allowed access to the network and will be assigned an address and a SIP address (step 506). Otherwise, no connection can be made to the network (step 504).

If the user of the communication device moves within the network N, he/she may move away from the first SIP server 100s₁ and closer to the second SIP server 100s₂ (step 508). If the communication device 200 moves from the cell Cs₁ defined by the first SIP server 100s₁ and into to the cell Cs₂ defined by second SIP server 100s₂ the communication device 200 is assigned a new SIP address—i.e. the SIP address of the second SIP server 100s₂ (step 510).

When the communication device 200 sends a signal to the base station B1-B5, the data is ‘encapsulated’ to form a data packet. Part of this encapsulation comprises adding the SIP address to the data.

The data packet is sent to the local base station (step 512) within the frequency channel allocated to the communication device 200 for that communication. Once the data packet has been received, the base station sends an acknowledgement to the communication device 200. If this is not received with a predetermined time (step 514), the communication device 200 should re-send the data packet.

The base station B1-B5 then sends the data packet to the server 100 providing the network N (step 516). Once the data packet has been received, the server 100 sends an acknowledgement to the base station. If this is not received with a predetermined time (step 518), the base station should re-send the data packet. Assuming the data packet has been received, the server 100 detects the SIP address and will be able to determine the location of the communication device 200 from its SIP address.

The data packet is then sent to the destination device with the location details attached (step 526). Once the data packet has been received, the destination device sends an acknowledgement to the server 100. If this is not received with a predetermined time (step 528), the server 100 should re-send the data packet. That destination device can then provide location specific services (step 530). If the SIP address is not recognised, an error message may be sent to the communication device 200, alerting the user thereof that a location specific service will not be available in this case (step 524).

1. A method of reducing the bandwidth required to operate a wireless network comprising transmitting at least a first and a second advertisement according to different network protocols in the same, or substantially the same, broadcast channel.

2. A method according to claim 1 in which the first advertisement is transmitted according to a cellular telephone network protocol.

3. A method according to claim 1 in which the second advertisement is transmitted according to the Session Initiation Protocol.

4. A method according to claim 1 in which the wireless network is a cellular network.

5. A method according to claim 4 in which one of the first and second advertisements covers more than one cell of the cellular network.

6. A method according to claim 1 in which the method is arranged such that at least one of the advertisements contains location information.

7. A method according to claim 1 in which the advertisement according to the first network protocol is encapsulated within the advertisement according to the second network protocol.

8. A method according to claim 1 in which the advertisements sent according to the first and second network protocols are transmitted using the same transmission protocol.

9. A processing unit comprising a transmitter arranged to transmit data in at least one broadcast channel wherein said transmitter is arranged to transmit a first advertisement according to a first network protocol in said broadcast channel and to also transmit a second advertisement according to a second network protocol in said broadcast channel, or substantially in said broadcast channel.

10. A processing unit according to claim 9 in which said processing unit comprises a server provided within a cellular network.

11. A processing unit according to claim 10 in which said processing unit comprises a base station within a cellular network.

12. A communication device comprising a receiver arranged to receive signals in at least one broadcast channel, said receiver further being arranged to receive a first advertisement transmitted according to a first network protocol in said broadcast channel and to receive a second advertisement transmitted in the same, or substantially the same, broadcast channel.

13. A wireless network comprising at least one transmitter arranged to transmit data in at least one broadcast channel, said transmitter being arranged to transmit a first advertisement according to a first network protocol in said broadcast channel and a second advertisement according to a second network protocol in said broadcast channel, or substantially said broadcast channel.

14. A wireless network according to claim 13 which comprises a cellular network.

15. A machine readable medium holding instructions which when loaded onto a processing unit cause that processing unit to provide data for transmission by a transmitter arranged to transmit data in at least one broadcast channel such that the transmitter will transmit a first advertisement according to a first network protocol in said broadcast channel and will also transmit a second advertisement according to a second network protocol in said broadcast channel, or substantially in said broadcast channel.

16. A machine readable medium holding instructions which when loaded onto a communication device cause that communication device to function as the communication device arranged to receive signals in at least one broadcast channel, said signals comprising a first advertisement transmitted according to a first network protocol in said broadcast channel and a second advertisement transmitted in the same, or substantially the same, broadcast channel.

17. A method of locating a communication device within a cellular network comprising transmitting an advertisement that contains location information.

18. A method according to claim 17 which comprises an advertisement according to SIP.

19. A method according to claim 17 in which location information provided by the advertisement extends over more than one cell of the cellular network.

20. A method of reducing the hardware required to provide a cellular network by reducing the number of processing units required to transmit advertisements, said method comprising transmitting more than one advertisement within the same, or substantially the same, broadcast channel.

22. A machine readable medium holding instructions which when loaded on to a computing device cause said computing device to locate a communication device within a cellular network comprising transmitting an advertisement that contains location information.
